(19) United States
(12) Patent Application Publication
(10) Pub. No.: US 2009/0073389 A1
(43) Pub. Date: Mar. 19, 2009

(54) DEVICE AND METHOD FOR LARGE-SCREEN PROJECTION OF DIGITAL IMAGES ONTO A PROJECTION SCREEN

(76) Inventor: Christoph Dobler, Germering (DE)

Correspondence Address: CESARI AND MCKENNA, LLP, 88 BLACK FALCON AVENUE, BOSTON, MA, 02210, US

(21) Appl. No.: 11/856,257

(22) Filed: Sep. 17, 2007

(51) Int. Cl. G03B 21/14

(52) U.S. Cl. 353/20

(57) ABSTRACT

A device for the large-screen projection of digital images onto a projection screen having a light source and a reflector for producing a cone of light and for projecting the light emitted by the light source through an image generator and an object lens onto the projection screen and having a 3D-sectored polarization wheel which can be driven by a motor and which comprises polarizing sectors in the optical path of the light emitted by the light source, wherein the motor of the polarization wheel is configured such that it can drive the wheel in increments, and an electronic control unit is provided which synchronizes the motor of the polarization wheel and synchronizes with the image sequencing of the image generator such that each individual image is projected through the polarizing sector associated with its polarization.

### BACKGROUND OF THE INVENTION

The invention relates to a device for the large-screen projection of digital images onto a projection screen, said device having a light source and a reflector for producing a cone of light and for projecting the light emitted by the light source through an image generator and an object lens onto the projection screen and having a motor-drivable 3D-sectored polarization wheel having polarizing sectors in the optical path of the light emitted by the light source. The invention further relates to a method for the large-screen projecting of digital images onto a projection screen in which a light source emits light which produces a cone of light by means of a reflector and projects it through an image generator and an object lens onto the projection screen and in which a motor-drivable 3D-sectored polarization wheel having polarizing sectors rotates in the optical path of the light emitted by the light source.

The method of spatial image projection, also called stereo projection, is used to project large-screen images which a viewer can perceive as three-dimensional. This method of stereoscopic viewing is based on the necessary separation of the left and right image, also known as channel separation. In the process, two images, each reflecting one scene from the perspective of a viewer's eyes, are projected as superimposed so-called half-images or partial images and displayed on a projection surface. In so doing, it must be ensured that the viewer only sees one partial image with his one eye and the other partial image with his other eye so that the human brain will generate a spatial impression.

Polarizing filter technology is a known projection technique for realizing this concept in video or other projectors which uses polarized light to achieve the channel separation. In so doing, polarizing foils are offset 90° from one another in front of the projection lenses and in the polarized glasses worn by the viewers. The half-image for the viewer's left eye is then polarized horizontally, for example, and the half-image for the right eye vertically. By wearing polarized glasses, the lenses of which are calibrated accordingly, the viewer sees the one half-image through the one lens of the polarized glasses and the other half-image through the other lens of the polarized glasses and thus the entire image as a whole has a 3D effect. A metallic-coated projection screen is necessary to maintain the polarization of the light. A white projection screen would re-scatter the light again and negate the channel separation.

In order to realize the concept described at the outset, a device is required which lends the two half-images the necessary polarization. Such a device is known for example from DE 196 26 097 C1 which provides for a rotatable polarization disk in the optical path of the light emitted by a light source. The polarization disk is circular and comprises sectors having polarizing filters of differing polarization directions. Turning the polarization disk alternatingly polarizes the beam of light passing through it. Because the disk is rotating, the beam of light passes through a rotating polarizing sector of the polarizing filter during polarization. The polarized beam of light thus contains a mixture of different polarization directions through which the beam of light passes, the homogeneity of which is smaller the larger the sector is. This diminishes the distinct separation between the differently polarized half-images and thus also the 3D effect obtainable.

Due to the continuous rotation of the disk, it can also happen that the beam of light emitted by the light source will not completely or precisely pass through the sector area of the polarizing sector correspondingly provided to it for polarization but instead a part of the beam of light will also pass through the area of another, neighboring polarizing sector of different polarization direction. The result of this simultaneous overlapping of the emitted beam of light onto two polarization sector areas having differing polariza-tions is the so-called swimming effect, which occurs at or between the edges of the images projected in this manner through the beam of light. This however considerably detracts from the image definition of the images projected onto the projection screen and thus reduces the quality of the three-dimensional image representation for the viewer. This overlapping effect moreover lowers the potential light output when the beam of light does not pass fully through the sector area of the correspondingly provided polarization direction. This likewise has a negative effect on the quality of the 3D digital image projected.

### SUMMARY OF THE INVENTION

The task on which the present invention is therefore based is that of providing a further development of a large-screen projection device having a polarizing mechanism as well as a corresponding method for the large-screen projection of digital images onto a projection screen using a device of the type cited at the outset in such a way so as to avoid the problems and disadvantage known from the prior art and discussed above and, in particular, which achieves an appreciable increase in image quality.

This task is solved in accordance with the invention by a large-screen projection device for projecting digital images onto a projection screen of the type cited at the outset in which the motor for the 3D-sectored polarization wheel is configured such that it can drive the 3D-sectored polarization wheel in increments and that an electronic control unit synchronizes the motor and synchronizes the incremental rotation of the 3D-sectored polarization wheel with the image sequencing of the image generator such that each individual image is projected through the polarizing sector associated with its polarization.

The task is further solved by a method for the large-screen projection of digital images onto a projection screen in which a light source emits light which produces a cone of light with a reflector and projects its onto the projection screen through an image generator and an object lens, and in which by means of a motor-drivable 3D-sectored polarization wheel having polarizing sectors rotates in the optical path of the light emitted from the light source, whereby the motor of the 3D-sectored polarization wheel is driven incrementally and an electronic control unit synchronizes the motor and synchronizes the incremental rotation of the 3D-sectored polarization wheel with the image sequencing of the image generator such that each individual image is projected through the polarizing sector associated with its polarization.

“Light engine” is the technical term for the image generator known to one skilled in the art. The two terms will be used interchangeably in the following.

As is generally known, 3D-sectored polarization wheels are divided into sectors having differing polarizations. The number of polarizing sectors provided on a 3D-sectored polarization wheel is thereby always a multiple of 2*n, whereby n=1, 2, 3, 4, etc., so that equally-sized segmented areas of polarizing sectors (S₁, S₂, S₃, S₄, Sₙ) can be configured on a 3D-sectored polarization wheel at distances of 30°, 45°, 60° or 90°, etc.

An essential point of the invention lies in the fact that the synchronized control of the image generator and the 3D-sectored polarization wheel according to a given image sequencing from the image generator enables a synchronized and incremental rotation of a 3D-sectored polarization wheel such that each individual image generated by the image generator, each generated successively for the left and the right eye of the viewer, is precisely projected through the polarizing sector associated with its polarization. The projection of the desired images through the beam of light thus occurs in a manner that the respective half-image generation is synchronized to the alternating polarizations of the 3D-sectored polarization wheel. This thereby effectively prevents the swimming effects as described above as well as a loss of light output.

Preferred embodiments of the invention device are specified in the dependent claims and the invention method is specified in the method claims.

Three alternatives are preferably provided for the arrangement of the 3D-sectored polarization wheel within the device as a whole:

A first alternative consists of the 3D-sectored polarization wheel with the corresponding control components being arranged in the optical path of the light emitted by the light source between the light source and the image generator. This thus enables integrating the 3D-sectored polarization wheel as a component within the image generator above the lamp housing so as to be easily accessible for maintenance and repair purposes. The 3D-sectored polarization wheel can moreover be positioned virtually as close to the focus of the cone of light as desired, whereby the size, i.e. the scale, of the 3D-sectored polarization wheel can be dimensioned so as to be smaller.

A second alternative provides for the 3D-sectored polarization wheel with the corresponding control components being arranged between the image generator and the object lens. Although the accessibility of the 3D-sectored polarization wheel suffers somewhat thereby, this arrangement alternative also enables any close positioning relative the focus of the cone of light emitted by the image generator and thus an advantageous influencing of the scale of the 3D-sectored polarization wheel.

A third alternative provides for the 3D-sectored polarization wheel to be arranged to follow the basic object lens. Existing projector systems can hereby be very easily retrofitted by mechanically affixing the 3D-sectored polarization wheel in front of the lens.

A further preferred embodiment of the invention provides for the image generator to be allocated its own electronic control unit. It has the task of synchronizing the image sequencing and synchronizing with the advancing sectors of the 3D-sectored polarization wheel in such a manner that each individual image is projected through the polarizing sector (S₁, S₂, S₃, S₄, Sₙ) associated with its polarization. This increases the reliability of the image generator since upon the loss of one electronic control unit, the other electronic control unit can perform the identical functions in terms of synchronizing the individual images with the 3D-sectored polarization wheel. A further advantage of providing both the image generator as well as the 3D-sectored polarization wheel with its own electronic control unit is that either the control for the image generator or the control for the 3D-sectored polarization wheel can alternatingly perform a so-called “master function” in the interacting synchronization between the image generator and the 3D-sectored polarization wheel.

One advantageous embodiment of the method according to the invention provides for the electronic control unit of the light engine to synchronize the image sequencing with the advancing sectors of the 3D-sectored polarization wheel such that each individual image is projected through the polarizing sector (S₁, S₂, S₃, S₄, Sₙ) associated with its polarization.

Specific invention embodiments and drawings are set forth below to specify the invention in greater detail.

### BRIEF DESCRIPTION OF THE DRAWINGS

In the drawings:

FIG. 1. a schematic representation of a device for large-screen projection in accordance with the prior art;

FIG. 2 a schematic representation of a first embodiment of a device for large-screen projection in accordance with the present invention;

FIG. 3 a schematic representation of a second embodiment of a device for large-screen projection in accordance with the present invention;

FIG. 4 a schematic representation of a third embodiment of a device for large-screen projection in accordance with the present invention; and

FIG. 5a to 5d different depictions of a 3D-sectored polarization wheel having differing sector segments.

### DETAILED DESCRIPTION OF AN ILLUSTRATIVE EMBODIMENT

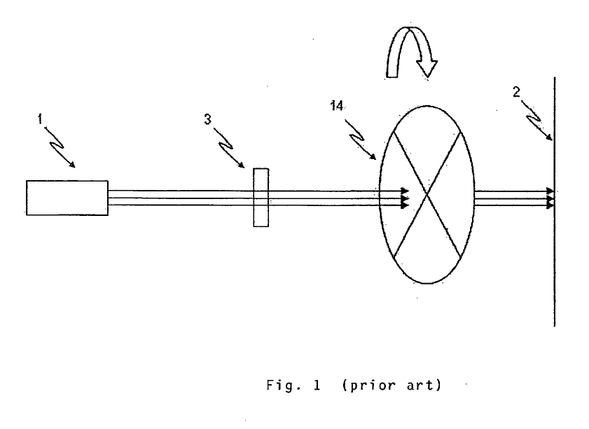

FIG. 1 is a schematic and simplified view of a projector system which can project images to be perceived as three-dimensional as is known for example from DE 196 26 097 C1. Light is conducted here from a light source 1 through a lens system 3 in the direction of the arrows. Omitted for purposes of simplification is the image generator as necessary to display images with such a projector system. A rotatable polarization wheel 14 shown with the example of four sectors, which in this illustration of the embodiment is arranged behind the lens system 3, ensures that the individual half-images generated will be polarized differently. For example, the half-image for the left eye will be polarized horizontally, the half-image for the right eye vertically. The continuously rotating polarization wheel thereto synchronously alternates polarization direction with the generation of the half-images. Due to the differing polarizations, a viewer wearing glasses provided with the appropriate polarizing filters, perceives the projected image as three-dimensional.

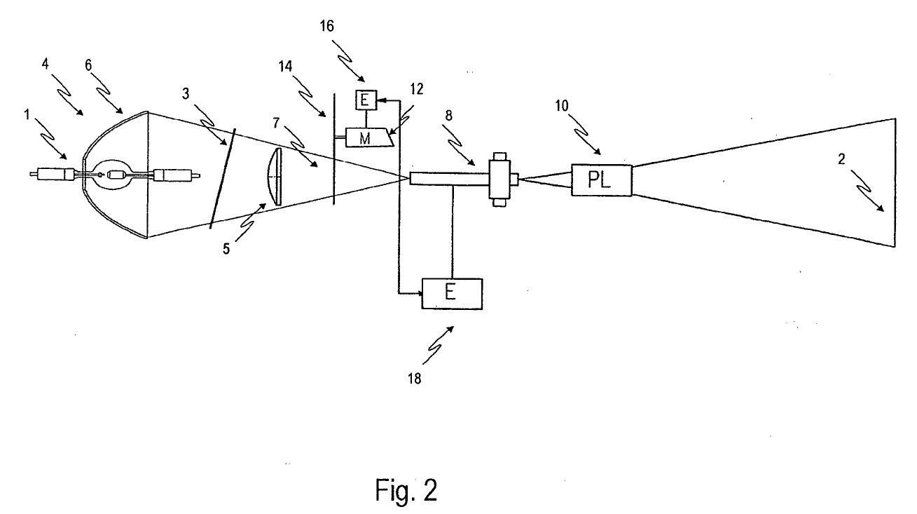

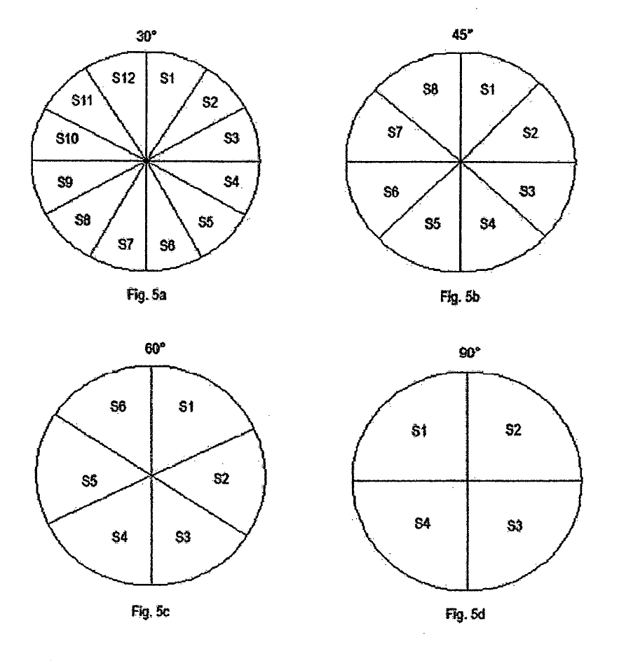

FIG. 2 is a schematic sectional view of a first embodiment of the device according to the invention for large-screen projection. The complete device as depicted includes a projection lamp 1 in the form of a high-pressure xenon lamp or another type of commercially-available lamp such as for instance an LED, HTI or HMI, which is composed of a light source 4 and a reflector 6 and which produces a cone of light 7. Based on the specific projection technology or manufacturer, this cone of light 7 is directed through an optional deflection mirror/UV or IR filter 3, a convergent lens 5 and thereafter through an image generator 8 and an object lens 10 and projected onto a projection screen 2. The image generator 8 is the heart of the digital video/cinematic projector which, depending on the specific projection technology or manufacturer, can be used with a known technology such as for instance DLP, DMD, LCD, LCOS, SXRD, D-ILA or the 1-chip or 3-chip technology. In the terminology of the field, it is known as “light engine” for short and comprises a known electronic control unit 18 which controls the provision of the left and right half-images as described above. A 3D-sectored polarization wheel 14 is arranged in the optical path of the light emitted by the light source 4—in this embodiment between the projection lamp 1 and the image generator 8. The 3D-sectored polarization wheel 14 is divided into 2*n polarization sectors (S₁, S₂, S₃, S₄, Sₙ) (see FIGS. 5a to 5d). The polarization wheel 14 is driven in increments by means of a motor 12 which can be configured for example as a brushless servo motor with an encoder or as a stepper motor. The polarization wheel 14 is allocated an electronic control unit 16 which synchronizes motor 12 and synchronizes the image sequencing with the image generator 8 such that each individual image is projected through the polarization sector (S₁, S₂, S₃, S₄, Sₙ) associated with its polarization. To this end, the electronic control unit 18 of the image generator 8 is coupled with electronic control unit 16 so as to relay the necessary control signals for the synchronized control of motor 12 of the 3D-sectored polarization wheel 14. Which of the two electronic control units 16, 18 takes over the so-called “master function” in this synchronization is in principle at one's selective discretion.

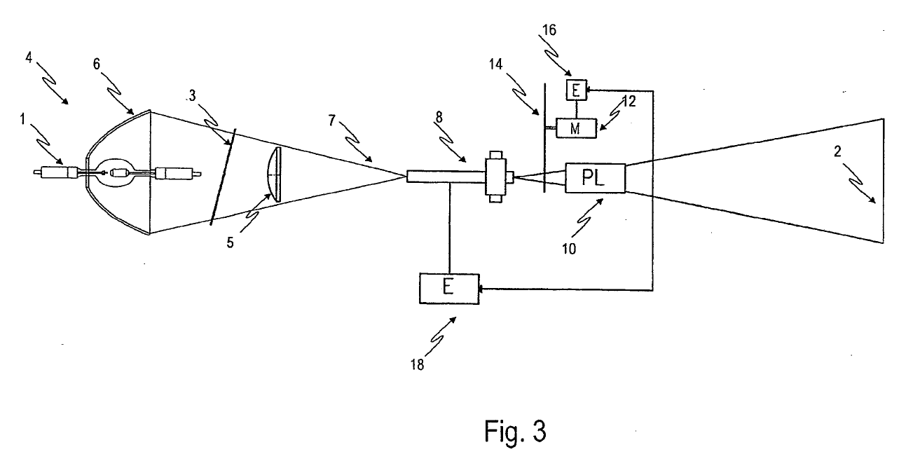

FIG. 3 is a schematic sectional view of a second embodiment of the device according to the invention for large-screen projection. This second embodiment differs from the first embodiment of FIG. 2 in that the 3D-sectored polarization wheel 14 is arranged here between the image generator 8 and the object lens 10.

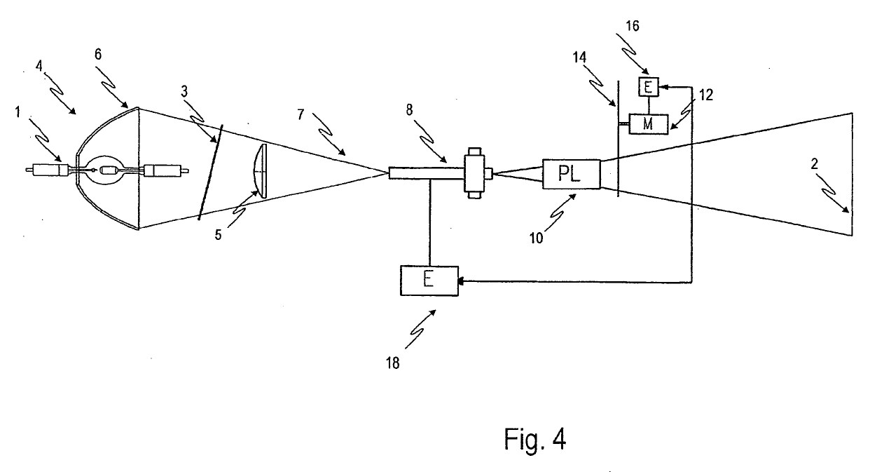

FIG. 4 is a schematic sectional view of a third embodiment of the device according to the invention for large-screen projection. This third embodiment differs from the previous embodiments of FIG. 2 and FIG. 3 in that the 3D-sectored polarization wheel 14 is now arranged to follow the object lens 10. This embodiment is particularly suited to subsequently upgrading pre-existing projector systems accordingly since the 3D-sectored polarization wheel 14 only needs to be electrically/electronically coupled to the image generator 8 by means of an applicable connection.

FIG. 5 shows different representations of a 3D-sectored polarization wheel having different sector segments. The number of sectors on the polarization wheel always corresponds to a multiple of 2*n, whereby n=1, 2, 3, 4, etc. In this way, one obtains 3D-sectored polarization wheels which are divided into, for example, 30° sectors as in FIG. 5a, 45° sectors as in FIG. 5b, 60° sectors as in FIG. 5c, and 90° sectors as in FIG. 5d.

### REFERENCE NUMERALS

1 projection lamp
2 projection screen
3 deflection mirror/UV/IR filter
4 light source
5 convergent lens
6 reflector
7 cone of light
8 image generator/“light engine”
10 object lens
12 motor
14 3D-sectored polarization wheel
16 3D drive electronic control unit
18 “light engine” electronic control unit

What is claimed is:

1. A device for the large-screen projection of digital images onto a projection screen (2) having a light source (4) and a reflector (6) for producing a cone of light (7) and for projecting the light emitted by the light source (4) through an image generator (8) and an object lens (10) onto the projection screen (2) and having a 3D-sectored polarization wheel (14) which can be driven by a motor (12) and which comprises polarizing sectors (S₁, S₂, S₃, S₄, Sₙ) in the optical path of the light emitted by the light source (4), wherein the motor (12) of the 3D-sectored polarization wheel (14) is configured such that it can drive the 3D-sectored polarization wheel (14) in increments, and an electronic control unit (16) is provided which synchronizes the motor (12) of the 3D-sectored polarization wheel (14) and synchronizes with the image sequencing of the image generator (8) such that each individual image is projected through the polarizing sector (S₁, S₂, S₃, S₄, Sₙ) associated with its polarization.

2. The device according to claim 1, wherein the 3D-sectored polarization wheel (14) is arranged between the light source (4) and the image generator (8).

3. The device according to claim 1, wherein the 3D-sectored polarization wheel (14) is arranged between the image generator (8) and the object lens (10).

4. The device according to claim 1, wherein the 3D-sectored polarization wheel (14) is arranged to follow the object lens (10).

5. The device according to claim 1, wherein the image generator (8) is allocated its own electronic control unit (18) which synchronizes the image sequencing and synchronizes with the advancing sectors of the 3D-sectored polarization wheel (14) in such a manner that each individual image is projected through the polarizing sector (S₁, S₂, S₃, S₄, Sₙ) associated with its polarization.

6. A method for the large-screen projecting of digital images onto a projection screen (2) in which a light source (4) emits light which produces a cone of light (7) by means of a reflector (6) and projects it through an image generator (8) and an object lens (10) onto the projection screen (2), and in which a 3D-sectored polarization wheel (12) which can be driven by a motor (12) and having polarizing sectors (S₁, S₂, S₃, S₄, Sₙ) rotates in the optical path of the light emitted by the light source (4), said method comprising the steps of causing the motor (12) to drive the 3D-sectored polarization wheel (14) in increments; and utilizing an electronic control unit (16) to synchronize the motor (12) and to synchronize the incremental rotation of the 3D-sectored polarization wheel (14) with the image sequencing of the image generator (8) such that each individual image is projected through the polarizing sector (S₁, S₂, S₃, S₄, Sₙ) associated with its polarization.

7. The method according to claim 6 including the step of allocating to the image generator (8) its own electronic control unit (18) which synchronizes the image sequencing, and in which the electronic control unit (18) of the image generator (8) synchronizes the image sequencing with the advancing sectors of the 3D-sectored polarization wheel (14) such that each individual image is projected through the polarizing sector (S₁, S₂, S₃, S₄, Sₙ) associated with its polarization.
